(19) United States
(12) Patent Application Publication
(10) Pub. No.: US 2012/0244508 A1
(43) Pub. Date: Sep. 27, 2012

(54) METHOD FOR REMOTELY PROCTORING TESTS TAKEN BY COMPUTER OVER THE INTERNET

(75) Inventor: Andrei Katz, New Hempstead, NY (US)

(73) Assignee: The American Paralegal Institute, Inc., Phoenix, AZ (US)

(21) Appl. No.: 13/070,693

(22) Filed: Mar. 24, 2011

(51) Int. Cl. G09B 7/00

(52) U.S. Cl. 434/362

(57) ABSTRACT

A method of proctoring an examination taken by a student at a remote site uses a student's computer connected over a network to a test administration server. Before a student takes a first examination, a pre-examination sample of the student's voice is recorded. At a designated examination time, a network connection is made between the student's computer and the server computer. The student logs-in and is prompted to make a telephone call, to enter a code on the telephone keypad, and to provide a start-of-examination voice sample. After the student answers at least one exam question, and the answer is uploaded and removed, the student is prompted to make another telephone call, to enter a code, and to orally summarize or explain the prior answer. An instructor may letter retrieve and compare such voice samples to detect cheating.

### BACKGROUND OF INVENTION

1. Field of Invention

The present invention relates generally to the field of examination proctoring, and more specifically to the field of remotely monitoring and authenticating examinations taken by a student enrolled in an educational course for ensuring the integrity of the testing environment and minimizing the possibility of cheating.

2. Description of Related Art

Historically, educators of post-elementary school students have used examinations, or tests, as the vehicle for measuring a student's grasp of the subject matter being taught. The administration of an examination to a gathered group of students who are all physically present in a localized classroom, or test room, follows very common and simple procedures. The course instructor, or proctor, can physically distribute the exams to the students, monitor the students during the examination, and collect the examination papers at the end of the examination period.

A more recent trend for high school and college students is to take one or more courses “online” via a computer connection over the Internet. An article published in the Boston Globe newspaper on May 30, 2010 [“2014. Online high school courses grow in popularity”, by Michele Morgan Bolton] quotes one educational technology consultant who estimated that two million American high school students are already learning online, and that such number was expected to jump to 10 million by 2014. Similarly, in a report entitled “Learning on Demand—Online Education in the United States, 2009”, by I. Elaine Allen and Jeff Seaman, published in January 2010, and based upon responses from more than 2,500 colleges and universities, the authors concluded that over 4.6 million students were taking at least one online course during the fall 2008 term.

New issues arise in the administration of examinations when students are located remotely from the “classroom”. The proliferation of on-line courses offered through the Internet has posed significant challenges to current methods of examination proctoring, particularly when such courses are offered for college credit and/or applied toward a degree program. Challenges arise in the timing, security, and grading of such examinations. Particularly, there is the risk that a student registered to take a course will use a more-knowledgeable substitute, or proxy, to “stand-in” for the registered student during the examination, thereby inviting fraud. A proxy may be a person other than the registered student who either assists the registered student during the examination, or who outright takes the examination in place of the student. Cheating is obviously harder to detect when an instructor, or proctor, is not physically present at the site where the test is being taken. This security issue is compounded when examinations taken on-line must be evaluated by an instructor who may not have physically met any of his/her students.

Prior attempts to deal with the remote examination problem have varied. The most straight-forward approach is to insist that students who will be taking a test must appear at a designated test site that is monitored by a third-party proctor. This third-party proctor is not necessarily employed by, or affiliated with, the educational institution that conducts the course in which the student is to be tested. The proctor greets each student, inspects photographic identification for each such student, assigns the student to a computer within the proctored test room, and watches for any abnormal behavior during the period of the examination. While being reasonably reliable, this procedure requires the proctor and the student to be in the same physical location, and also requires the participation of a person to serve as the proctor in real time. This procedure does not allow for students to take the examination at the student's home or office.

U.S. Pat. No. 7,099,620 to Miller is an example of the remote testing site, including a local physically-present proctor, as described in the preceding paragraph. In Miller, students use a computer terminal to take an examination, and the examination questions appear on the student's computer screen. The student answers such questions by, for example, typing at the keyboard of the student's computer. Miller refers to this process as “computer based testing”, and notes several advantages over more traditional pencil and paper examinations. Miller further describes the extension of computer based testing to Internet based testing, wherein the student's computer is connected over the Internet to a remote web server that stores the examination questions, transmits the examination questions to the student's computer, and records the student's answers. Miller's disclosed system requires a dedicated test site at a school or university. The student must be physically present at the dedicated test site, and the student must use one of the work station computers at the dedicated test site to take the examination. Miller states that the dedicated remote examination site must be controlled to eliminate the possibility of cheating, and Miller further states that a proctor is located at each test site to administer the examination.

U.S. Pat. No. 7,308,581 to Geosimonian differs from Miller by allowing a student to take an examination online at a truly remote location, such as the student's home. Geosimonian strives to ensure that the person who is taking the examination is actually the student who is registered to take such examination. The student's computer includes a “biometric reader” that generates biometric data. For example, Geosimonian states that, in a preferred embodiment, the biometric reader is a camera for receiving images of the user's face. The images of the user's face generated by the camera are transmitted to a central server. In an alternate embodiment, Geosimonian states that the biometric reader is a microphone for capturing the student's voice. In this alternate embodiment, biometric data representative of the student's voice pattern is stored at a central server. Voice recognition software is used to compare the voice pattern stored at the central server with voice data generated by the microphone at the student's computer. Continued access to web pages on the central server is dependent upon whether the voice recognition software finds a match between the voice pattern stored at the central server with voice data generated by the microphone at the student's computer.

U.S. Pat. No. 7,483,670 to Walker, et al., discloses a method for allowing students to take tests at home using a home computer. After taking the test, the student calls an 800 telephone number to transmit the results of the test in the form of an encoded test result (a numeric score code). Walker states that the encoded test result may include biometric data related to the student. Walker further describes the optional use of a voice recognition system to provide absolute test taker identity verification, and states that the voice verification system may be located either at the central computer or at the local testing computer. When the voice recognition system is included in the central computer, test results will not be recorded in the central computer if there is no match. When the voice recognition system is included in the local testing computer, the test session will not start if there is no match.

Within U.S. Patent Application Publication No. US 2007/0117082 to Winneg et al., a method is disclosed for remotely monitoring an examination taken over the Internet. Winneg attempts to authenticate the identity of an authorized examination taker to prevent cheating, but without requiring the presence of a proctor at the location where the student is taking the test. Winneg does mention the use of proctors, but Winneg notes that such proctors need not be at the same physical location as the student. Winneg states that such proctors monitor live data, i.e., still pictures, video signals and/or audio signals of the environment surrounding the student taking the test, during the administration of the examination.

U.S. Patent Application Publication No. US 2007/0048723 to Brewer, et al., is also directed to proctoring tests taken over the Internet. In Brewer, a student about to take an examination at a remote testing site must first “register” by providing information about the student, which may include an audio sample of the test taker. Brewer states that this “registration data” is then compared by a comparison module within the central computer to “pre-supplied registration data” that is known to be valid for a particular test taker in order to determine whether the person taking the test is actually the person who is supposed to be taking the test. In addition, Brewer discloses methods for analyzing test response data and test response latency data for detecting instances of misconduct.

In U.S. Pat. No. 5,915,973 to Hoehn-Saric, et al., a method of remote proctoring is disclosed. A student wishing to take an examination first visits a registration site to register to take an examination. The registration site is used to input data about the student, and is also equipped with a biometric measurement device to record biometric data such as a fingerprint, a retinal image, a voice print, hand geometry, or other biometric data capable of identifying an individual. The verified biometric data is transferred to and stored by the central computer station for later comparison with test taker biometric data. his data is stored at the central computer. When the student is ready to take the examination, the student goes to a secure, automated testing kiosk that is installed within an existing building to take an examination. The testing kiosk includes a video camera for sending an audio-video signal to the central computer. The testing kiosk is linked to the central station, and transmits the audio-video signal to the central station. The testing kiosk includes a handset that a student can use to communicate with a remote proctor at the central station; two way communication between the student and the proctor is recorded and stored as proctoring data. When the student reports to the testing kiosk, the student is again required to provide biometric data, which is then compared to the verified biometric data already stored at the central station; if a match is lacking, the student is not permitted to sit for the examination.

Others have proposed the use of real time web cams, or other audio-visual signaling devices to continuously record the test environment proximate the student taking the test. However, unless a live proctor is employed to continuously monitor such audio-visual information in real time, the audio-visual signals need to be stored for later review. Since an examination may last for hours, and since many students may be simultaneously registered for a given course, the amount of electronic storage space required to store such audio-visual signals would quickly become unmanageable.

As will be apparent from the methods described above, known systems for proctoring examinations taken from remote sites, such as the student's home, tend to be complicated and expensive. In many instances, such known systems require the student's computer to include one or more “biometric” sensors that are not included in many home computers. In other instances, such known systems require the central computer to include sophisticated voice recognition software that may not function reliably in real time. There is a need for a system to automatically, and remotely, proctor examinations taken by students over the Internet from remote sites, that will significantly discourage any attempts by students to cheat, while being easy to use and inexpensive to implement.

It is therefore an object of the present invention to provide a method administering an examination to a student located at a remote site in a reasonably secure manner, without requiring the student to physically appear at a designated test site in the physical presence of a human proctor.

It is also an object of the present invention to provide such a method which allows the student to take such examination from the student's home, workplace, or from any location where a connection to the Internet is available.

It is a further object of the present invention to ensure that a student who is registered in an educational course is actually the person who takes an examination from a remote site.

Another object of the present invention is to provide a method for allowing a course instructor or proctor to detect instances of cheating by a student taking an examination.

Yet another object of the present invention to provide a method for remotely proctoring an examination being taken by a student from a remote site without requiring participation by an actual human proctor in real time during the period when the examination is being administered.

A still further object of the present invention is to provide a method of proctoring remote examinations which is simple and inexpensive to implement, yet which discourages students from attempting to cheat during an examination.

Still another object of the present invention is to provide such a method which avoids a requirement for the installation, or incorporation, of special software, webcams, microphones, biometric sensors, or other specialized equipment on, or within, the student's computer in order to take an examination.

These and other objects of the present invention will become more apparent to those skilled in the art as the description of the present invention proceeds.

### SUMMARY OF THE INVENTION

Briefly described, and in accordance with a preferred embodiment thereof, the present invention is directed to a method for administering an examination to a student located at a site remote from the location at which the examination questions are maintained. The student taking the examination connects the student's computer over a network, e.g., the Internet, to a test administration server computer when the examination is to be taken by the student. Before the examination is administered to the student, a pre-examination sample of the student's voice is recorded and stored for later reference by a course instructor. In the preferred embodiment, such recording is stored as a digital audio file in the test administration server computer, and is indexed to the student who generated such voice sample.

At the time for taking the examination, the student connects his or her computer over the network to the test administration server computer. The student “logs in” as by, for example, entering a user name and password previously assigned to such student. After the student logs in, the student is prompted to make a first telephone call to a test administrator telephone number. This prompt may be generated by, for example, displaying on the student's computer screen a message directing the student to call a specified telephone number. This telephone call may be made by the student by, for example, using a hard-wired land line telephone, by using a cellular telephone, or even by using a voice-over-internet-protocol (VOIP) telephone. Preferably, the student is also prompted to enter a numeric, or alphanumeric, code, either by pressing keys on the student's telephone device keypad or by speaking the code into the telephone; this code may be helpful to identify the student calling in, and for purposes of indexing a recording of the student's voice sample.

After the student calls the test administrator telephone number, and enters any required information using the telephone keypad, the student is requested to speak into the telephone for obtaining a sample of the student's voice as of the beginning of the examination (a “start of examination” voice sample. Preferably, a script is caused to be displayed on the student's computer screen, prompting the student to read a predetermined selection of words into the telephone during such telephone call. The start of examination sample of the student's voice transmitted via telephone during such call is recorded for later reference by a course instructor. Again, such start of examination voice sample is preferably stored as a digital audio file in the test administration server computer, and is indexed to the student who logged in. This first telephone call is then terminated.

Next, a first examination question is presented to the student via the student's computer. The examination question is displayed on the student's computer screen, along with an area for the student to input an answer to the question. Using a mouse, keyboard, or other input devices, the student enters the student's answer to the first examination question, and the student's answer is displayed on the student's computer screen along with the question being answered. When the student has completed his or her answer to the first examination question, the student enters a “submit” command, as by clicking on a “submit” button. The student's answer is then uploaded to the test administration server computer, and the first question and answer are then removed from the student's computer.

The above-described question and answer procedure can be repeated one or more times, before the student is prompted to make another telephone call to the test administrator. Alternatively, it could be the case that the student is prompted to make another telephone call to the test administrator immediately after the student submits an answer to the first question. In either case, the student is again prompted, via the student's computer, to make another telephone call during the examination to the test administrator, as for example, by displaying a message on the student's computer screen to call a specified telephone number. Preferably, the prompt message displayed on the student's screen also includes a code to be entered by the student during such telephone call, as by keypad entry or by speaking the code into the telephone; this code may be helpful to identify the student calling in, and for purposes of indexing a recording of the student's oral response. During this telephone call, an examination question that was previously answered by the student is again displayed on the student's computer screen. The student is prompted (via the computer screen) to orally provide information regarding such question during this second telephone call. For example, the student might be prompted to orally summarize the answer which the student previously submitted; alternatively, the student might be asked to indicate orally whether and why the previous answer to the question would be changed if one of the facts provided in such question were changed. The student's oral response provided during such telephone conference is again recorded for later reference by the course instructor. Again, the student's oral response is preferably stored as a digital audio file in the test administration server computer, and is indexed to the student who logged in to take the examination. This telephone call is then terminated.

The above-described question and answer procedure is repeated until all examination questions have been presented to the student. Either at random, or predetermined intervals, the student is prompted to call in to again orally provide information about a previously answered question, before being allowed to proceed to the next examination question. Each of such oral, telephoned responses is recorded, preferably as a digital audio file in the test administration server computer, and is indexed to the student who logged in to take the examination. Preferably, the student is prompted to call-in at least twice during the course of the examination to provide information orally about a previously answered test question.

With regard to the recording of the pre-examination sample of the student's voice, this step might again be accomplished by having the student log-in to the test administration server computer, and then prompting the student to call a specified telephone number displayed on the student's screen, having the student input a unique code on the student's telephone keypad, displaying a script to be read on the student's computer screen, and directing the student to read the script out loud for recording during such telephone call.

If desired, the pre-examination sample of the student's voice can be verified by requiring the student to personally appear before a notary or other authorized official, requiring the student to display a government-issued picture identification to the authorized official establishing the identity of the student, and recording a sample of the student's voice while the student is physically present before the authorized official. Alternatively, and if desired, the student could be required to appear before a webcam connected over a network to the test administration server computer, requiring the student to display a government-issued picture identification to the webcam establishing the identity of the student, and recording a sample of the student's voice while the student is physically present before the webcam and displaying such picture identification.

In the preferred embodiment of the present invention, the network browsing capability of the student's computer is disabled during the examination to prevent the student from sending or receiving data from the student's computer to any computer other than the test administration server computer during the administration of the examination. Also in the preferred embodiment of the present invention, the “cut-and-paste” clipboard capability of the student's computer is disabled during the administration of the examination. Both of such measures help further minimize efforts by a student to include within an answer information that is not original with the student.

When a course instructor, proctor, or other authorized official is ready to grade an examination, or investigate a suspected instance of cheating, for a particular student, the pre-examination voice sample, start of examination voice sample, and oral responses recorded during the examination, are all available for review, and are indexed by student. The course instructor can select the recorded audio files of the pre-examination sample of the student's voice, the start of examination voice sample, and the oral responses recorded during the examination, and compare such recordings to each other to detect any irregularities in the examination taken by the student. The course instructor can also listen to the oral responses concerning questions already answered by the student to determine whether the student is having unexpected difficulty summarizing an answer which the student had theoretically input himself or herself earlier in the examination.

### BRIEF DESCRIPTION OF THE DRAWINGS

FIG. 1 is a flowchart illustrating the steps performed, in the preferred embodiment of the present invention, to record an initial voice sample of a student before the student takes his or her first examination.

FIG. 2 is a flowchart illustrating steps performed by a course instructor to prepare an examination for access on a test administration server computer.

FIG. 3 is a flowchart illustrating the steps performed as a student prepares to take an examination by connecting the student's computer over the Internet to the test administration server computer.

FIG. 4 is a flowchart illustrating the steps performed while the examination is in progress.

FIG. 5 is a simulation of the screen prompt displayed to a student when the student records his or her initial voice sample.

FIG. 6 is a simulation of the screen prompt initially displayed to a student who has requested to take a particular examination.

FIG. 7 is a simulation of the screen prompt displayed to the student when the test administration server computer determines that it is time to record an oral response from the student about a prior question on the examination.

FIG. 8 is a simulation of the screen prompt displayed to the student after the student calls in using the student's telephone in response to the prompt of FIG. 7.

### DETAILED DESCRIPTION OF THE PREFERRED EMBODIMENTS

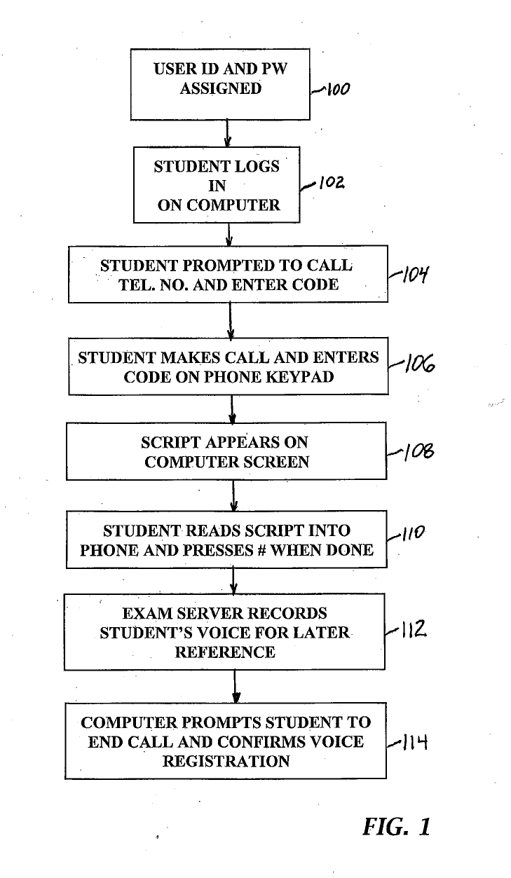

The preferred embodiment of Applicant's method for administering an examination to a student registered for an educational course will now be described with reference to accompanying FIGS. 1-8. Referring first to FIG. 1, a student who is registered to take courses through an educational institution or training program is assigned a User ID and password, as indicated by box 100. The User ID and password can be mailed to the student when the student registers, provided by telephone, by email or the like. After obtaining the student's User ID and password, the student provides an initial voice sample registration by logging into a test administration server computer over the Internet and entering the student's User ID and password, as indicated by box 102. This test administration server computer is located remotely from the student; it may be located at the main business offices of the educational institution, or it may be maintained by a third party host.

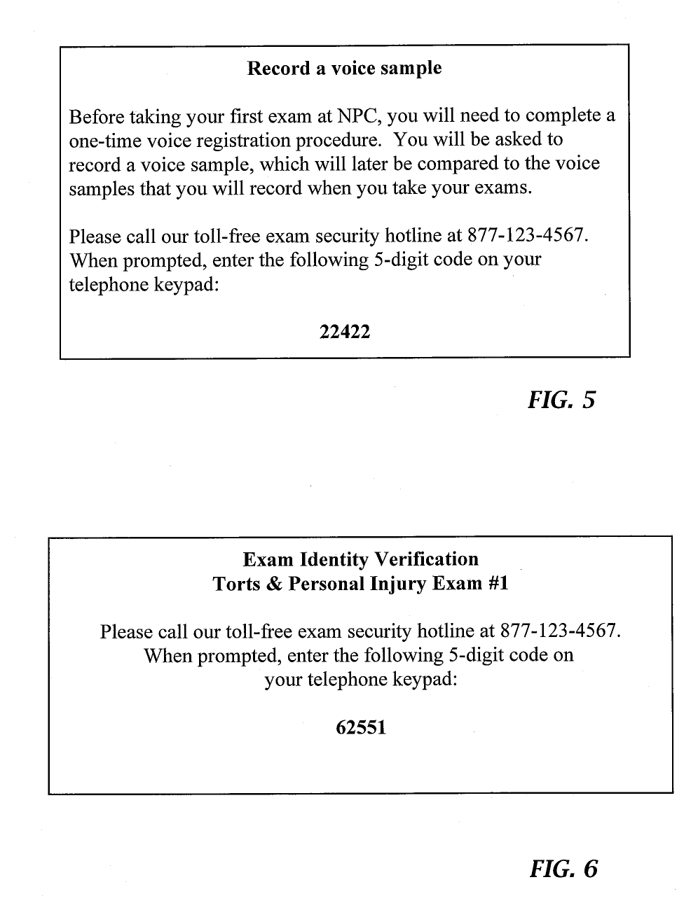

Upon confirming the student's User ID and password, the test administration server computer prompts the student to make a telephone call to a specified telephone number, and to enter a code, as indicated by box 104. The prompt message displayed on the student's computer screen, within the student's web browser window, may resemble the screen image shown in FIG. 5. In response to such prompt, the student dials the indicated telephone number, and, using the telephone key pad, enters the 5-digit numeric code displayed on the student's computer screen, as indicated by box 106. The test administration server computer includes a telephone call interface which invites the caller to enter such 5-digit numeric code. In the preferred embodiment, the telephone call interface recognizes the touch-tones of keypads depressed by the student during the call. However, those skilled in the art will appreciate that voice recognition software could also be used to allow the student to “speak” the characters of the code into the telephone, rather than depressing key pad buttons. The test administration server computer verifies that the 5-digit numeric code entered by the student via telephone is the proper code that was assigned to the student who logged in to provide an initial voice sample.

Assuming that the entered code matches the student who logged in, the test administration server computer then causes a script to be displayed on the student's computer screen, and requests the student to read such script into the telephone, and to press the “#” key on the student's telephone keypad after reading the script. This step is generally indicated by box 108 in FIG. 1. Following the instructions on the screen prompt, the student reads the script, and then dials “#” on the student's telephone key pad, as indicated by box 110. The test administration server computer records this initial, pre-examination voice sample provided by the student, as indicated by box 112. The pre-examination voice sample is preferably recorded as a digital audio signal (.wav, .mp3, etc.), and indexes the digital file along with the student's identification so that it may later be retrieved by a course instructor, proctor, school administrator, etc. If desired, the student's screen can then display a prompt to the student to terminate the phone call and/or to confirm to the student that the voice sample was successfully recorded, as shown by box 114.

If desired, and for added security, the process for obtaining the pre-examination voice sample may be modified to require the student to personally appear before an authorized official, for example, a notary, school official, or the like. In this case, the student is required to display a government-issued picture identification to the authorized official which positively establishes the identity of the student. After doing so, the student remains in the presence of such official while logging in via computer, and dialing in via telephone, to provide the pre-examination voice sample of the student's voice while the student is physically present before the authorized official. Alternatively, the student may be required to log in using a computer equipped with a webcam connected over the Internet to the test administration server computer, to display the student's face and government-issued picture identification to the webcam establishing the identity of the student, and to record the pre-examination sample of the student's voice while the student's face is physically present before the webcam and displaying such picture identification. While these techniques certainly increase the security of the disclosed method, Applicant believes that student's will be sufficiently discouraged from attempting to cheat on examinations even if such modifications are not adopted.

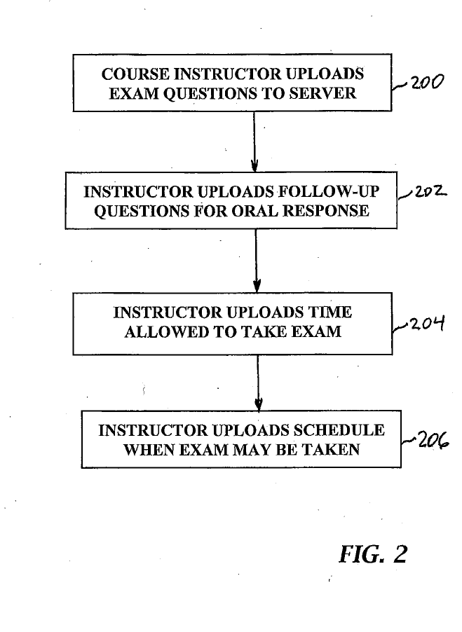

Turning to FIG. 2, the course instructor must prepare the test administration server computer to offer a particular examination before students can request to take the examination. The course instructor uploads the questions for a given examination to the test administration server computer, as indicated by box 200 in FIG. 2. The examination questions are typically of the type that require a short essay-style answer. At least one, and preferably two of such questions will ultimately be presented, for oral response, to students taking the examination for security purposes. If desired, the course instructor may upload a follow-up question related to at least one of the examination questions to be presented to the student for oral response during the examination, as indicated by box 202. For example, a follow-up question might be “would your answer to the previous question have changed if it were raining at the time of the incident, and if so, why?” Alternatively, the method of the present invention may be practiced without the need for supplemental follow-up questions; in this alternative, the original question might be presented again to the student, but without the answer already submitted by the student, and the student may then be prompted to orally state the answer previously typed in, and to provide a brief explanation of how the student arrived at such answer.

The test administration server computer also needs to know the amount of time that the instructor is allowing for each student to take the examination. Accordingly, as indicated by box 204, the course instructor uploads the allowed examination time. When a student is actually taking such examination, the student's computer screen displays a countdown clock timer showing the amount of time remaining to complete the examination. Finally, the course instructor may wish to limit the dates or times that students are permitted to take the examination. As indicated in box 206, the course instructor uploads the date(s) and time(s) when the examination is available to be taken by students.

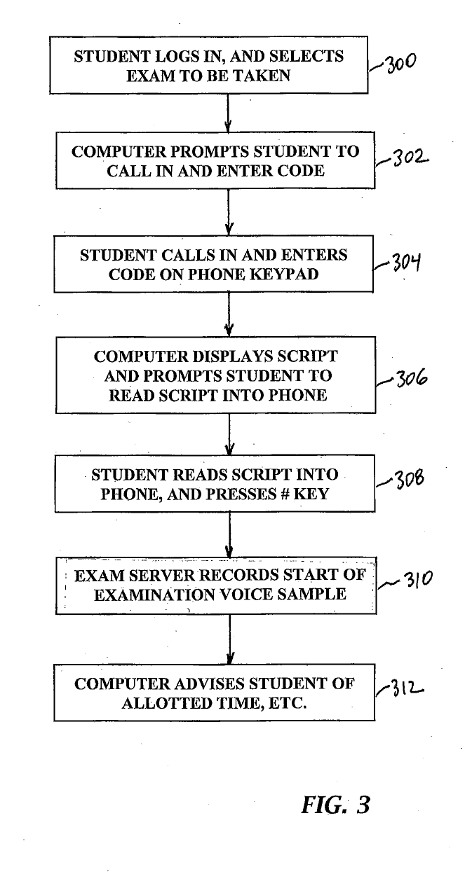

Now referring to FIG. 3, a student is ready to request taking an examination. The student operates the student's computer, and uses his or her web browser to link up with the test administration server computer over the Internet. As shown in box 300, the student logs-in by entering the student's User ID and password, and then selects the particular examination which the student is ready to take. Preferably, the test administration server computer verifies that the student who logged in is actually registered in that course, and that the course instructor has allowed enrolled students to take this particular examination at the present time. If so, the test administration computer server causes the student's web browser to display a prompt to make a telephone call to the test administrator at a telephone number displayed in such prompt; preferably, the prompt screen displayed on the student's computer also displays a code to be input by the student, using the telephone key pad, during such telephone call, as indicated in box 302. For example, when the student logs in to take Exam #1 for the course entitled “Torts & Personal Injury”, the student may see the screen prompt shown in FIG. 6, providing the telephone number to be called, and the code to be entered.

After reading the screen prompt shown in FIG. 6, the student calls-in and enters the code on the telephone key pad, as indicated by box 304. The test administration computer server then causes the student's web browser to display a script to be read by the student into the telephone, as indicated by box 306. The student then reads the words of the displayed script into the student's telephone, and presses the “#” key on the student's telephone to signal that the student has finished reading the script, as shown in box 308. The test administration server computer records this “start of examination” voice sample as a digital audio file, and again indexes this file along with identification for the student who logged-in to take the examination, as designated by box 310. Like the above-described pre-examination voice sample, the course instructor, proctor, or school administrator can later reply the “start of examination” voice sample to determine whether the recorded sample is consistent with other voice samples recorded for the same student.

Immediately before the examination begins, and the clock begins to run, the computer screen of the student's computer displays to the student the amount of time for the examination to be completed, as shown by box 312. A warning that students will not be allowed to go back and change prior answers may also be displayed before the first examination question is displayed. Also, in the preferred embodiment of the present invention, if not already done so, the network browsing capabilities of the student's computer are temporarily disabled during the examination to prevent the student from sending or receiving data from the student's computer to any computer other than the test administration server computer. As a further safeguard, the “cut-and-paste” clipboard capability of the student's computer, at least within the web browser window in which the student must enter his or her answer, is also disabled during the administration of the examination.

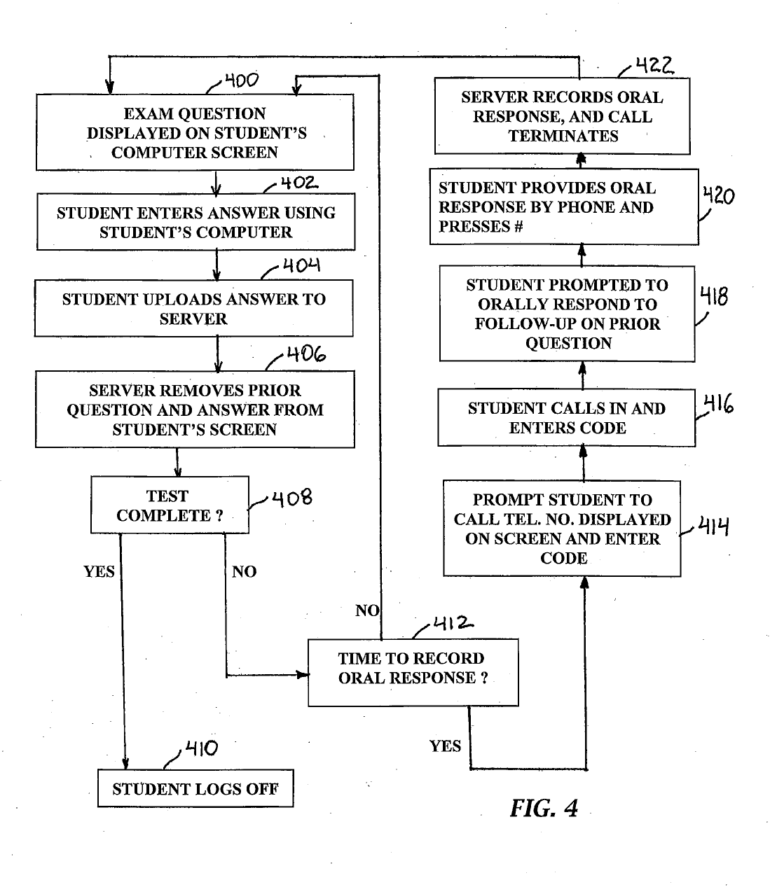

Turning to FIG. 4, examination questions are now presented to the student, one at a time. The flow of the steps involved starts with box 400, when the first examination question is presented to the student on the student's computer screen, within the student's web browser. The web page displaying the question also includes an answer box, bearing resemblance to the document window of a word processing program, allowing the student to input his or her answer into the answer box by typing on the keyboard of the student's computer, as indicated by box 402. As mentioned above, the cut-and-paste clipboard feature that is ordinarily available in a word processing program is disabled with respect to the answer box in the student's browser; accordingly, the user may neither paste text from an outside source into the answer window, nor may the user “copy” the answer typed by the user for later reference. When the student is satisfied with his or her answer, the student clicks on a “Submit” button, which uploads the student's answer to the test administration computer server, as indicated by box 404. After recording the student's answer, the test administration computer server causes both the question, and the student's answer to disappear from the student's computer screen, as represented by box 406. If all examination questions have been presented to the student, and the test has been completed, or if the allotted time has run out, the student will be so notified, and the student logs out, as indicated boxes 408 and 410.

Thus far in this description, the student has answered only the first examination question, so the examination is not completed yet, and program flow transfers to box 412. Box 412 is a decision box to decide whether it is time to request the student to make a telephone call, for security purposes, to the test administrator. For example, it could be the case that the student is always required to call the test administrator after answering each series of three questions; in that case, the student would be prompted to call in after answering the third question, after answering the sixth question, etc. Alternatively, the number of questions to be answered before the student is prompted to call-in may be more randomized, so that the student can not know in advance when, or how often, such calls will need to be made. Preferably, the student is prompted to call the test administrator at least twice during the course of the examination. Whatever criteria are decided upon by the course instructor, a proctor, or school administrators, box 412 will check to see whether the student should be prompted to call-in before the next examination question is presented. If the decision is “no”, then program flow transfers from box 412 back up to box 400, and the process just described is repeated.

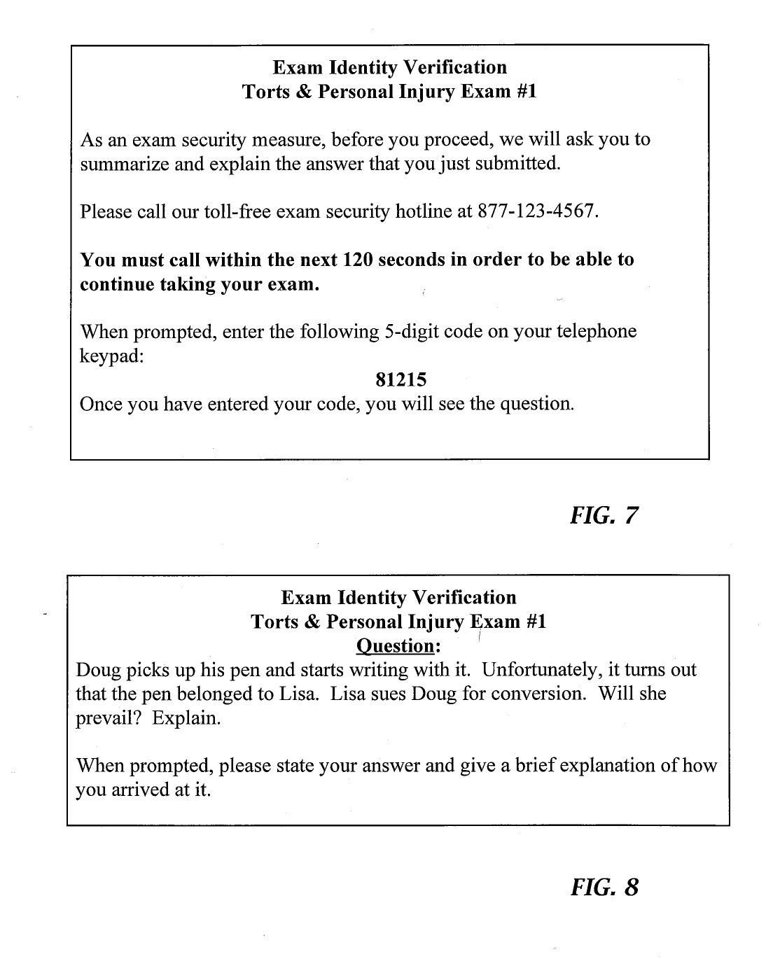

Still referring to FIG. 4, if the decision at box 412 is “yes”, then program flow transfers to box 414, and the student is prompted to call the test administrator and enter a displayed code via the student's telephone keypad, as indicated by box 414. FIG. 7 is a simulation of the prompting screen displayed to the student in the student's web browser when program flow has reached box 414. Upon receiving such prompt, the student makes a telephone call to the telephone number displayed, and upon making such connection, the student enters, via the telephone keypad, the code displayed on the student's screen, as indicated by box 416. Upon receiving the proper code, the test administration computer server causes the student's web browser to display to the student, via the student's computer, an examination question previously answered by the student, but without the answer already entered by the student, as indicated by box 418.

In the preferred embodiment, the question that is presented to the student at box 418 is the question that the student most recently answered. FIG. 8, simulates the prompt screen displayed in the student's web browser by box 418. As indicated in FIG. 8, the student is prompted to orally re-state the student's answer to the previous question, and to provide an explanation of how the student arrived at such answer. As indicated by box 420, the student then orally provides the requested information, via the student's telephone, perhaps pressing the “#” key on the telephone keypad when the student is finished. As designated by box 422, the test administration server computer again records the student's voice during this telephone call, storing the recorded audio track as an indexed digital audio file for reference by a course instructor, proctor, or school administrator. The telephone call is terminated, and program flow transfers back to box 400 for presenting the next examination question to the student.

After the examination is completed, and either before or during the grading process, the course instructor, proctor, “grader”, or a school administrator, is provided access to all of the aforementioned recorded audio files for a particular student, since these digital files are indexed by student. For example, the “proctor” can a) play back, and listen to, the pre-examination sample of the student's voice; b) play back, and listen to, the “start of examination” voice sample of the student's voice recorded at the beginning of the examination; and c) play back, and listen to, student's oral responses when the student was prompted to summarize and explain one or more answers already uploaded by the student. The proctor, course instructor, or other listener can then compare such recordings for consistency to detect any irregularities in the examination taken by the student. For example, if the voice changes significantly from one recording to another, there may be a situation wherein the person who sat for the examination was not actually the student registered to take the course. Even if the recordings match, and the registered student was actually present to take the examination, the proctor, course instructor, or other listener can listen to the student's oral responses regarding answers to prior questions. If the student has difficulty accurately summarizing the answer that was submitted, or if the explanation provided by the student as to how the student arrived at such answer does not make sense, the proctor, course instructor, or school administrator can investigate further to determine whether the student was being coached by an assistant. Where suspicions are aroused, the student may be asked to repeat the test in the physical presence of a proctor. This feature of the invention is likely enough to discourage both the registered student, and a potential “coach” from trying to cheat on the examination. If outright fraud is detected, the student could be failed, or expelled.

As noted above, the test administration server computer includes a telephone call interface system which preferably includes an automated attendant system that “answers” incoming telephone calls placed to one of the test administrator telephone numbers. The automated attendant can handle multiple telephone lines simultaneously, so a student taking an examination does not receive a busy signal. The recording and indexing of the incoming calls by students is performed by so-called “call recording software”, and is handled in a manner similar to that long used to record voice mail messages for multiple extensions at a business. The test administration server computer includes interactive voice response (IVR) technology, e.g., the IVR system available from The Plum Group, Inc. of New York, N.Y. under the registered trademark “Plum Voice”. IVR is a technology that allows a computer to detect voice and keypad inputs during a phone call. Using IVR technology, the test administration server computer prompts the student, via telephone, with either prerecorded prompts or synthesized speech, and the user can respond by touch-tone keys and/or voice.

Those skilled in the art will now appreciate that an improved method has been described for administering an examination to a student located at a remote site. The disclosed system maintains reasonable security, allows the student to take the examination from almost any location that has Internet connectivity, and avoids the need for a student to be in the physical presence of a human proctor. The method disclosed above provides reasonable assurance that a student who is registered in an educational course is actually the person who is taking the examination remotely. Sufficient safeguards are provided for allowing a course instructor or proctor to detect instances of cheating by a student taking an examination, while avoiding the need for participation by an actual human proctor in real time during the period when the student is taking the examination. The disclosed method is relatively simple and inexpensive to implement, avoids the need for real-time monitoring or specialized biometric sensors, yet serves to significantly discourage students from attempting to cheat during an examination.

While the present invention has been described with respect to a preferred embodiment thereof, such description is for illustrative purposes only, and is not to be construed as limiting the scope of the invention. Various modifications and changes may be made to the described embodiments by those skilled in the art without departing from the true spirit and scope of the invention as defined by the appended claims.

I claim:

1. A method for administering an examination to a student registered for an educational course, the student using a student computer to take such examination, the method comprising the steps of:
a. recording a pre-examination sample of the student's voice before administration of the examination, and storing said recording for later reference by a course instructor;
b. requiring the student to connect the student's computer over a network to a test administration server computer when the examination is to be taken by the student;
c. prompting the student, following step b, to make a first telephone call to a test administrator after the student's computer connects to the test administration server computer;
d. recording a sample of the student's voice during the first telephone call for reference by a course instructor;
e. following step d, presenting at least one examination question to the student via the student's computer, and allowing the student to input the student's answer to such examination question via the student's computer;
f. removing from the student's computer the examination question, and the student's answer thereto, recited in step e;
g. prompting the student, via the student's computer, to make a second telephone call during the examination to the test administrator;
h. presenting to the student, via the student's computer, an examination question previously answered by the student, and prompting the student to orally provide information regarding such question during the second telephone call;
I. recording the information provided orally by the student in step h for reference by a course instructor.

2. The method recited by claim 1 wherein the step of recording a pre-examination sample of the student's voice includes the steps of:
a. requiring the student to personally appear before an authorized official;
b. requiring the student to display a government-issued picture identification to the authorized official establishing the identity of the student; and
c. recording a sample of the student's voice while the student is physically present before the authorized official.

3. The method recited by claim 1 wherein the step of recording a pre-examination sample of the student's voice includes the steps of:
a. requiring the student to appear before a webcam connected over a network to the test administration server computer;
b. requiring the student to display a government-issued picture identification to the webcam establishing the identity of the student; and
c. recording a sample of the student's voice while the student is physically present before the webcam and displaying such picture identification.

4. The method recited by claim 1 wherein the step of recording a pre-examination sample of the student's voice includes the step of displaying to the student a script to be read by the student when making the recording of the pre-examination sample of the student's voice.

5. The method recited by claim 1 wherein the step of recording a pre-examination sample of the student's voice includes the steps of requesting the student to call a telephone number and requesting the student to provide such voice sample during such telephone call.

6. The method of claim 5 wherein the step of recording a pre-examination sample of the student's voice includes the step of requesting the student to input a code during such telephone call before requesting the student to provide a sample of the student's voice.

7. The method recited by claim 1 wherein the step of requiring the student to connect the student's computer over a network to a test administration server computer includes the step of requiring the student to provide log-in data to the test administration server computer to identify the student.

8. The method recited by claim 1 wherein the step of prompting the student to make said first telephone call to the test administrator includes the step of displaying a telephone number to be called on the student's computer screen.

9. The method recited by claim 8 wherein the step of prompting the student to make said first telephone call to the test administrator includes the step of displaying a code to be input by the student during said first telephone call.

10. The method recited by claim 8 wherein the step of prompting the student to make said first telephone call to the test administrator includes the step of displaying a script to be read by the student during said first telephone call.

11. The method recited by claim 1 wherein the step of prompting the student to make said second telephone to the test administrator includes the step of displaying a telephone number to be called on the student's computer screen.

12. The method recited by claim 11 wherein the step of prompting the student to make said second telephone call to the test administrator includes the step of displaying a code to be input by the student during said second telephone call.

13. The method recited by claim 1 wherein the step of prompting the student to orally provide information during the second telephone call includes the step of requesting the student to orally provide the student's answer to an examination question already answered by the student.

14. The method recited by claim 1 wherein steps (e) and (f) are repeated for each question included in the examination.

15. The method recited by claim 14 wherein steps (g), (h) and (i) are performed at least twice during the course of the examination.

16. The method recited by claim 1 including the further step of disabling the network browsing capabilities of the student's computer during the examination to prevent the student from sending or receiving data from the student's computer to any computer other than the test administration server computer during the administration of the examination.

17. The method recited by claim 1 including the further step of disabling the “cut-and-paste” capability of the student's computer during the administration of the examination.

18. The method recited by claim 1 including the further steps of:
a. playing back to the course instructor the pre-examination sample of the student's voice;
b. playing back to the course instructor the sample of the student's voice recorded during the first telephone call; and
c. playing back to the course instructor the information provided orally by the student during the second telephone call;
whereby the course instructor compares such recordings to detect any irregularities in the examination taken by the student.
